(19) United States
(12) Patent Application Publication
(10) Pub. No.: US 2007/0286578 A1
(43) Pub. Date: Dec. 13, 2007

(54) Recording/reproducing apparatus and content moving method

(75) Inventor: Naomiki Kobayashi, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/797,287

(22) Filed: May 2, 2007

(30) Foreign Application Priority Data
May 12, 2006 (JP) 2006-134037

(51) Int. Cl. H04N 5/91

(52) U.S. Cl. 386/95; 386/E05.001

(57) ABSTRACT

A recording/reproducing apparatus according to the invention includes a first recording unit which records video content data in a recording medium, a second recording unit which records accompanying information, including information on reproduction of the video content data, in the recording medium in the form of a file different from the content data, a first transmission unit which deletes the video content data from the recording medium while transmitting the video content data recorded in the recording medium to an external device on a network through a network interface in response to a content data moving instruction, and a second transmission unit which transmits the accompanying information on the video content data transmitted by the content data moving unit to the external device through the network interface in response to the content data moving instruction, and deletes the accompanying information from the recording medium.

### CROSS-REFERENCE TO RELATED APPLICATIONS

This application is based upon and claims the benefit of priority from Japanese Patent Application No. 2006-134037, filed May 12, 2006, the entire contents of which are incorporated herein by reference.

### BACKGROUND

1. Field

The present invention relates to a recording/reproducing apparatus which moves copyright-protected digital video contents to an external device through a network.

2. Description of the Related Art

Sometimes various digital video contents recorded in an information recording medium are accompanied with information such as each reproducing apparatus and user reproducing information. Examples of accompanying reproducing information include a pause, a subtitle, and a language. For example, the pause information indicates a stop position in contents when reproduction is stopped in midstream during reproduction of the contents. When an instruction is provided to reproduce the contents sometime after the reproduction is stopped, the reproduction is resumed from the position where the reproduction has been stopped based on the pause information. The function of resuming the reproduction from the position where the reproduction has been stopped is referred to as resume function.

For example Jpn. Pat. Appln. KOKAI Publication No. 2006-18859 discloses a technique concerning the accompanying reproducing information. In a reproducing apparatus disclosed in Jpn. Pat. Appln. KOKAI Publication No. 2006-18859, even if a reproducing setting condition is not inputted in each time contents are reproduced, the contents can be reproduced in the setting of user's preference, or the reproduction can be performed from the interrupted point.

Recently, for all the contents, so-called “copy once” signal which permits contents to be copied only for one generation is multiplexed in video contents received through digital broadcasting such as BS digital broadcasting and terrestrial digital broadcasting. The video contents having a copy-once attribute cannot be copied in another medium, but only a moving process (MOVE) in which the contents is moved while the original contents is deleted is permitted.

In a recording and reproducing apparatus, usually the content accompanying information is managed by a database in a recording medium such as an HDD in which the contents are stored. Frequently the content accompanying information is not stored in the same area (file) as the contents, but is stored in another area (another file). The content accompanying information is never erased when the contents are moved in the recording and reproducing apparatus in which the contents are stored. However, in the copy-once contents, when the contents are moved to an external apparatus, the contents corresponding to the accompanying information does not exist in the recording and reproducing apparatus. Furthermore, because the external apparatus which is a moving destination of the contents does not have the accompanying information, it is difficult to control the reproduction using the accompanying information.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 shows a schematic configuration of a system to which the invention is applied;

FIG. 2 is a block diagram showing a schematic configuration of recording/reproducing apparatuses 101a and 101b as a recording/reproducing apparatus 101;

FIG. 3 shows a push type content moving method;

FIG. 4 shows a pull type content moving method; and

FIG. 5 shows an accompanying information moving method according to another embodiment.

### DETAILED DESCRIPTION

Various embodiments according to the invention will be described hereinafter with reference to the accompanying drawings. In general, according to one embodiment of the invention, there is provided a recording/reproducing apparatus comprising: a content data recording unit which records video content data in a recording medium in a form of a file; an accompanying information recording unit which records accompanying information, including information on reproduction of the video content data, in the recording medium in the form of another file; a network interface which conducts data communication with an external device through a communication network; a content data moving unit which deletes the video content data from the recording medium while transmitting the video content data recorded in the recording medium to the external device through the network interface in response to a content data moving instruction; and an accompanying information moving unit which transmits the accompanying information on the video content data transmitted by the content data moving unit to the external device through the network interface in response to the content data moving instruction, and deletes the accompanying information from the recording medium.

According to the embodiment, the accompanying information-based function such as the resume function can be utilized in the external apparatus which is the moving destination of the contents, even if the copyright-protected digital contents are moved to the external apparatus.

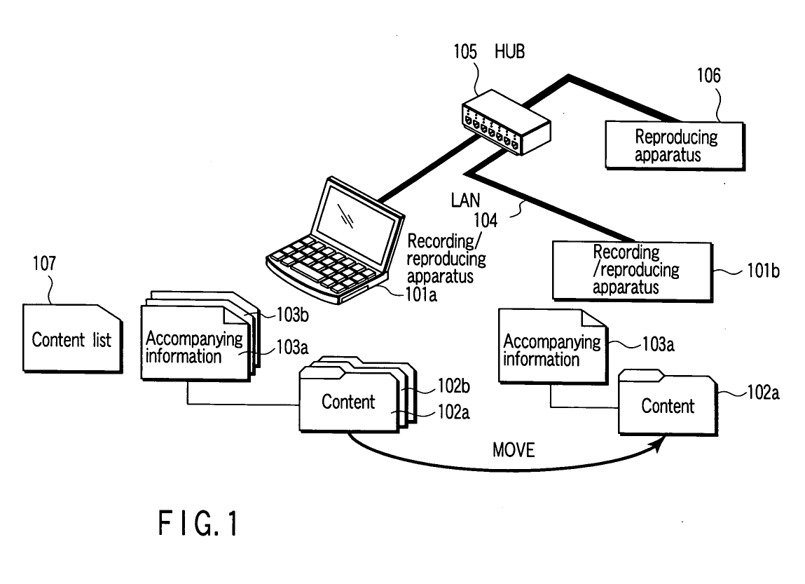

FIG. 1 shows a schematic configuration of a system to which the invention is applied. Recording/reproducing apparatuses 101a and 101b which are servers and a reproducing apparatus 106 which is a display device are network-connected through a hub 105 by an Ethernet cable 104.

The network is a home LAN in which communication is conducted pursuant to a protocol such as Internet Protocol (IP). The recording/reproducing apparatuses 101a and 101b and the reproducing apparatus 106 conduct communication with one another by UPnP (Universal Plug and Play) on the assumption that contents are transmitted and received using a copyright protection technique such as a digital transmission content protection over internet protocol (DTCP-IP).

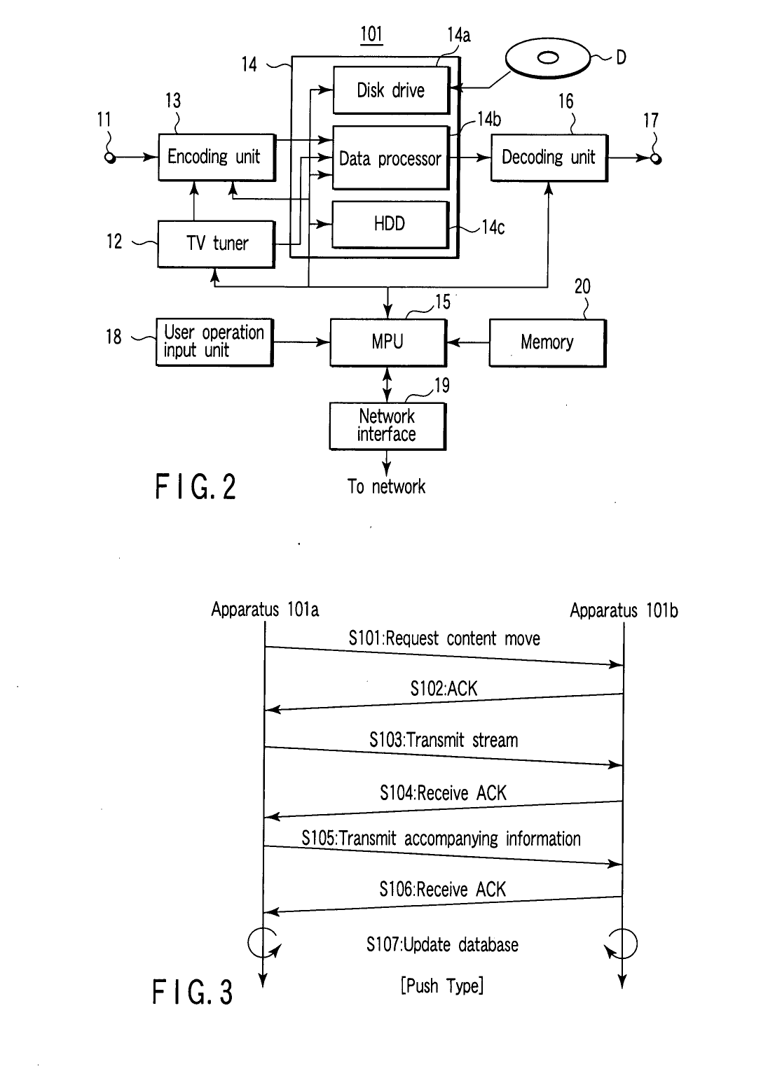

FIG. 2 is a block diagram showing a schematic configuration of the recording/reproducing apparatuses 101a and 101b as a recording/reproducing apparatus 101. The recording/reproducing apparatus 101 can be implemented as a PC or a DVD recorder.

The recording/reproducing apparatus 101 includes a recording and reproducing unit 14, a microcomputer (MPU, i.e., main control device) 15, a TV tuner 12, an encoding unit 13, a decoding unit 16, and a user operation input unit 19. The recording and reproducing unit 14 records an input video signal in a recording medium. The MPU 15 controls the recording and reproduction of the recording and reproducing unit 14, and also controls operation of each unit.

The TV tuner 12 can receive the digital broadcasting. The TV tuner 12 outputs a transport stream (TS) to a data processor 14b when receiving the digital broadcasting, and outputs an analog signal to the encoding unit 13 when receiving the analog broadcasting. The encoding unit 13 performs A/D conversion and encoding (compression) of the analog signal from the TV tuner 12 or an AV input terminal 11, and outputs the signal to the data processor 14b.

The recording and reproducing unit 14 includes a disk drive unit 14a, the data processor 14b, and an HDD 14c. The disk drive unit 14a can record and reproduce information in and from a disk D produced according to a DVD standard. Large-capacity data can be recorded in the HDD 14c.

Under the control of the MPU 15, the data processor 14b supplies the recording data from the encoding unit 13 or the tuner 12 to the HDD 14a, and supplies a reproduction signal from the HDD 14a to the decoding unit 16.

Under the control of the MPU 15, the data processor 14b supplies the recording data which is output from the encoding unit 13 to the disk drive 14a, and captures the reproduction signal of the disk D from the disk drive 14a to supply the reproduction signal to the decoding unit 16. Under the control of the MPU 15, the data processor 14b updates management information recorded in the disk D or the HDD 14a, and deletes the recorded data.

The decoding unit 16 decodes (decompresses) video information which is output from the recording and reproducing unit 14. An AV output terminal 17 is connected to the decoding unit 16 to supply the decoded reproduction information to the reproducing apparatus such as a television set.

The MPU 15 executes a control program recorded in a memory 20 according to an instruction input through the user operation input unit 18. The network interface 19 conducts communication with the external apparatus connected to the network under the control of the MPU 15.

An operation according to an embodiment of the invention will be described below.

As shown in FIG. 1, plural contents (for example, broadcasting programs) 102a, 102b, . . . are stored in the HDD 14c of the recording/reproducing apparatus 101a, and each of the contents has copy management information in which copy is prohibited. That is, in each of the contents, after the digital broadcasting is received and recorded in the HDD 14c, the copy is prohibited although the content can be moved to another recording medium.

Pieces of accompanying information 103a, 103b, . . . are also stored as a file in the HDD 14c in association with the contents. The accompanying information is one which relates to the reproduction of the content, and includes the pause information (stop position information), the subtitle, and the language. The content accompanying information is not stored in the same area (file) as the content, but is stored in another area (another file). A content list 107 indicating a list of the recorded contents is also stored in the HDD 14c. The plural contents 102a, 102b, . . . , the pieces of accompanying information 103a, 103b, . . . , and the content list 107 are the data which the data processor 14b records in the HDD 14c under the control of the MPU 15.

The reproducing apparatus 106 accesses the recording/reproducing apparatuses 101a and 101b to refer to the content list 107, and thereby the reproducing apparatus 106 can specify the content to be reproduced. At this point, in the case where the pause information is recorded as the accompanying information in the specified content, the reproduction from the pause position can be specified to the recording/reproducing apparatus.

Content movement according to the embodiment of the invention will be described below.

As for the movement of the content, it is assumed that the content recorded in the HDD 14c is moved to the recording/reproducing apparatus 101b because a free space is decreased in the HDD 14c of the recording/reproducing apparatus 101a. In another case, when children of a user want to watch a currently-broadcasting TV program on TV while the user reproduces and watches the recorded content on TV, the user stops the currently-reproduced content to move the content to the recording/reproducing apparatus 101b installed in another room, and the user watches the content.

In the embodiment, when the content 102a is moved, the content accompanying information 103a is also moved to the recording/reproducing apparatus 101b which is the destination of the content 102a. After the content 102a is moved, the recording/reproducing apparatus 101b which is the destination of the content 102a stores the accompanying information 103a while associated with the content 102a. On the other hand, in accordance with the movement of the content 102a, the recording/reproducing apparatus 101a which is the source of the content 102a deletes both the content 102a and the accompanying information 103a.

Examples of the method of moving the content 102a include a method in which the recording/reproducing apparatus 101a deletes the whole of the content 102a from the HDD 14c after confirming that the transmission of the content 102a to the recording/reproducing apparatus 101b is completed and a method in which the deletion is sequentially performed from the data transmitted to the recording/reproducing apparatus 101b in the content 102a recorded in the HDD 14c.

In the embodiment, it is assumed that the recording/reproducing apparatus 101a deletes the whole of the content 102a after confirming that the transmission of the content 102a to the recording/reproducing apparatus 101b is completed.

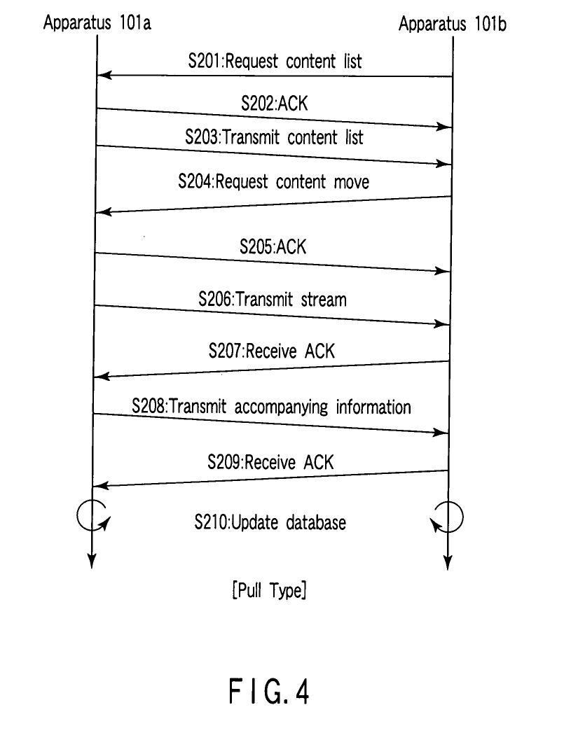

As shown in FIGS. 3 and 4, the method of moving the content 102a includes two patterns, i.e., a push type (FIG. 3) in which the apparatus 101a which is the source of the content triggers the apparatus 101b and a pull type (FIG. 4) in which the apparatus 101b which is the destination of the content triggers the apparatus 101a. In the push type of FIG. 3, the apparatus 101a transmits a content moving request to the apparatus 101b. On the other hand, in the pull type of FIG. 4, the apparatus 101b transmits the content moving request to the apparatus 101a.

The movement in the push type will be described first. The recording/reproducing apparatus 101a (hereinafter referred to as apparatus 101a) specifies the content based on the content list 107, and transmits a MOVE request of the specified content to the recording/reproducing apparatus 101b (hereinafter referred to as apparatus 101b) (S101). At this point, it is assumed that the content 102a is specified. When the apparatus 101b receives the MOVE request, the apparatus 101b sends back an ACK signal to the apparatus 101a (S102). The ACK signal indicates the confirmation that the apparatus 101b has received the MOVE request.

When the apparatus 101a receives the ACK signal, the apparatus 101a transmits a coded data stream of the content 102a to the apparatus 101b (S103). When the apparatus 101b correctly receives the content 102a, the apparatus 101b sends back the ACK signal indicating the confirmation of the reception to the apparatus 101a (S104).

When the apparatus 101a receives the ACK signal, the apparatus 101a transmits the file of accompanying information 103a on the content 102a to the apparatus 101b (S105). When the apparatus 101b correctly receives the accompanying information 103a, the apparatus 101b sends back the ACK signal indicating the confirmation of the reception to the apparatus 101a (S106).

When the apparatus 101a receives the ACK signal, the apparatus 101a deletes the content 102a and the accompanying information 103a on the content 102a, and the apparatus 101a deletes the information (such as title name and contraction image) concerning the content 102a in the content list 107. Therefore, the apparatus 101a updates the database in the HDD 14c (S107).

Then, the pull type movement will be described. In the pull type movement, the apparatus 101b transmits a request of the content list 107 to the apparatus 101a (S201). When the apparatus 101a receives the request of the content list 107, the apparatus 101a transmits the ACK signal to the apparatus 101b, and then the apparatus 101a transmits the content list 107 (S202 and S203).

The apparatus 101b specifies the content based on the received content list 107, and the apparatus 101b transmits the MOVE request of the specified content to the apparatus 101a (S204). At this point, it is assumed that the content 102a is specified. When the apparatus 101a receives the MOVE request, the apparatus 101a sends back the ACK signal indicating the confirmation of the reception to the apparatus 101b (S205), and transmits the coded data stream of the content 102a to the apparatus 101b (S206). The processes from S207 are similar to the steps S104 to S107 in the push type movement of FIG. 3.

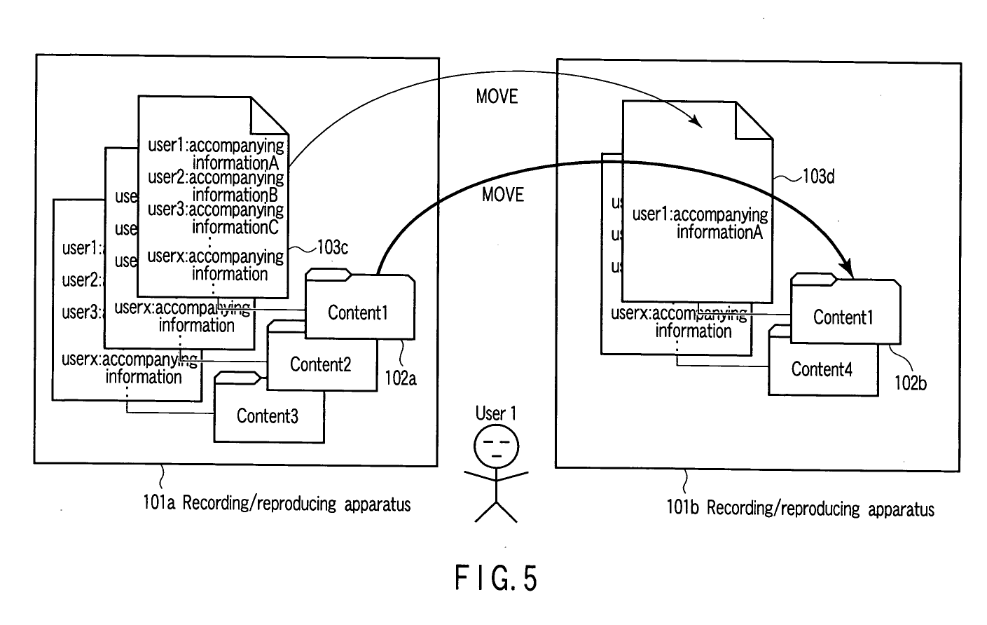

An accompanying information moving method according to another embodiment will be described below with reference to FIG. 5.

In the embodiment, plural pieces of accompanying information (such as resume information) A, B, C, . . . are recorded as the accompanying information 103c on the one content. The plural pieces of accompanying information A, B, C, . . . are recorded by plural users 1, 2, 3, . . . .

For example, plural user buttons are provided in a remote controller, each user operates the recording/reproducing apparatus after pressing the user button allocated to the user, and the recording/reproducing apparatus 101 identifies the user to produce the accompanying information. Therefore, the accompanying information 103c having the plural pieces of accompanying information A, B, C, . . . for the one content can be realized. For example, in the case where the recording/reproducing apparatus 101 can be operated with a portable telephone, the recording/reproducing apparatus 101 identifies the portable telephones to produce the accompanying information. Therefore, the accompanying information 103c having the plural pieces of accompanying information A, B, C, . . . for the one content can be realized.

Thus, the content accompanying information can include reproduction information (pause position information) of each user who uses the recording/reproducing apparatus 101. When the content is reproduced, the recording/reproducing apparatus 101 initially identifies the user by the remote controller, and specifies the content to provide the reproducing instruction. Therefore, the recording/reproducing apparatus 101 can reproduce the content from the last stop position using the accompanying information corresponding to each user.

The accompanying information moving method can be devised according to various settings in moving the content. For example, as shown in FIG. 4, the pieces of accompanying information on other users are not required for a user 1 who moves the content 102, and sometimes the user 1 makes a request of only the own accompanying information. In such cases, the recording/reproducing apparatus is set such that only the own accompanying information is moved to the apparatus 101b which is the destination of the content.

As described above, according to the embodiment of the invention, the accompanying information-based function such as the resume function can be utilized in the external apparatus which is the moving destination of the contents, even if the copyright-protected digital contents are moved to the external apparatus.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A recording/reproducing apparatus comprising:
a content data recording unit which records video content data in a recording medium in a form of a file;
an accompanying information recording unit which records accompanying information, including information on reproduction of the video content data, in the recording medium in the form of another file;
a network interface which conducts data communication with an external device through a communication network;
a content data moving unit which deletes the video content data from the recording medium while transmitting the video content data recorded in the recording medium to the external device through the network interface in response to a content data moving instruction; and
an accompanying information moving unit which transmits the accompanying information on the video content data transmitted by the content data moving unit to the external device through the network interface in response to the content data moving instruction, and deletes the accompanying information from the recording medium.

2. The recording/reproducing apparatus according to claim 1, wherein the accompanying information includes resume information indicating a reproduction stop position of the video content data.

3. The recording/reproducing apparatus according to claim 2, wherein the accompanying information includes a plurality of pieces of resume information which are produced for a piece of video content data in response to reproduction stop instructions of a plurality of users.

4. The recording/reproducing apparatus according to claim 3, wherein the accompanying information moving unit transmits only the resume information corresponding to the external device to the external device in said plurality of pieces of resume information which are produced for a piece of video content data, the external device being a destination of content data.

5. A video content data moving method in a system in which a plurality of recording/reproducing apparatuses are connected to a communication network, the method comprising:
recording video content data in a recording medium in a form of a file;
recording accompanying information, including information on reproduction of the video content data, in the recording medium in the form of another file;
transmitting the video content data recorded in the recording medium to the network in response to a content data moving instruction, and deleting the transmitted video content data from the recording medium;
transmitting the accompanying information on the transmitted video content data to the network in response to the content data moving instruction, and deleting the accompanying information from the recording medium; and
receiving the video content data and the accompanying information thereof through the network, and recording the video content data and the accompanying information thereof in another recording medium.

6. The video content data moving method according to claim 5, wherein the accompanying information includes resume information indicating a reproduction stop position of the video content data.

7. The video content data moving method according to claim 5, wherein the accompanying information includes a plurality of pieces of resume information which are produced for a piece of video content data in response to reproduction stop instructions of a plurality of users.
